(19) United States
(12) Patent Application Publication
(10) Pub. No.: US 2007/0088750 A1
(43) Pub. Date: Apr. 19, 2007

(54) Method and system for geospatially enabling electronic communication protocols

(76) Inventors: Mark E. Dumas, Vienna, VA (US); James Stokes, Richmond, VA (US); Wesley Hildebrandt, Vienna, VA (US); Jason Surratt, Gaithersburg, MD (US)

Correspondence Address: WILLIAMS MULLEN, 8270 GREENSBORO DRIVE, SUITE 700, MCLEAN, VA, 22102, US

(21) Appl. No.: 11/543,630

(22) Filed: Oct. 5, 2006

Related U.S. Application Data
(60) Provisional application No. 60/723,813, filed on Oct. 5, 2005.

(51) Int. Cl. G06F 17/00

(52) U.S. Cl. 707/104.1

(57) ABSTRACT

The present invention provides a system and method for geospatially enabling electronic communication protocols. The automatic attachment of additional information to standard communication protocols georeferences the origin and destination of all data passing through the protocols. Georeferenced data transport allows for efficient aggregation from and broadcast to spatial regions and locations through a spatially hierarchical routing network that processes, filters, and redirects data at the lowest level possible. Georeferencing also facilitates location-sensitive data requests and continuously updating situational awareness.

### REFERENCE TO RELATED APPLICATIONS

This application claims the benefit pursuant to 35 U.S.C. §119(e) of U.S. provisional patent application Ser. No. 60/723,813, filed Oct. 5, 2005 and titled “Method and System for Geospatially Enabling Electronic Communication Protocols,” the disclosure of which is incorporated herein by reference.

### FIELD OF THE INVENTION

The present invention relates to communication protocols, and more specifically pertains to a method and system for geospatially enabling electronic communication protocols to facilitate, among other things, communications, knowledge and rapid, informed response within a geospatially hierarchical communications network.

### BACKGROUND OF THE INVENTION

In data communication networks, it is common to employ several protocols arranged in layers. For example, the ISO Open Systems Interconnection (OSI) Reference Model or a portion thereof is frequently employed to deal with communication protocols and network architectures. The protocols involved implement different mechanisms over different transport media with different performance goals, but they all have two things in common: raw data to be transferred via the protocol and a way of directing that data to the intended recipient(s). As shown in FIG. 1, the seven layers of the OSI reference model 10 are the Application Layer 12, the Presentation Layer 13, the Session Layer 14, the Transport Layer 15, the Network Layer 16, the Data Link Layer 17 and the Physical Layer 18. For any given network, it may be that only a subset of these layers is employed or that two or more layers are merged.

The Application, Presentation, Session and Transport layers are used whenever a message passes to or from a user. The Network, Data Link and Physical layers are used when messages pass through a host computer. The specific functions of each layer are known to those of ordinary skill in telecommunications.

Each layer employs the services of the layers below it and provides services to the layers above it. Thus, for example, the Network Layer, which is responsible for routing and forwarding data, i.e., sending it in the right direction to the right destination on outgoing transmissions and receiving incoming transmissions at the packet level, is dependent upon the Data Link Layer to provide character and message synchronization as well as error correction. The Data Link Layer is, in turn, dependent upon the Physical Layer to actually transmit and receive information as electrical signals on the network.

An apparatus implementing a collection of protocol layers, such as the seven layers of the OSI Reference Model or a subset or variant thereof, is commonly referred to as a protocol stack. For example, the TCP/IP model can be described as a 4-layer model on the OSI model, as shown at 20 in FIG. 2. The Data Link layer 25 takes the place of the Data Link and Physical Layers and allows a host to send IP packets of a network. Ethernet is a sample implementation of the Data Link layer. In some representations of TCP/IP, the Data Link and Physical Layers exist independently, making TCP/IP a five layer stack in such a representation.

The Network layer 24 presents data packets into any network and delivers them to the destination independently of one another. As no connection is established first, packets may not be received in order, but the order handling is accommodated by the upper layers (i.e., TCP). The implementation of the Network layer is the IP protocol. The Transport layer 23 is used to ensure dialog among peer entities, as in the OSI model. One of the possible implementations for this layer is TCP (Transmission Control Protocol), which delivers packets from one machine on a network to another machine on the same network. By splitting up the message, the TCP puts the message in a form that can be handled by the Network layer. TCP also reorganizes the incoming data packets on the receiving machine in order to reconstruct the initial message and handles the flow control of the connection. The Application layer 22 in FIG. 2 is directly bound to the Transport layer. The Application layer manages all high level protocols, such as FTP, SMTP, HTTP and Telnet, for example.

One of the shortcomings of current protocols is that they do not provide geospatial data routing information except in the most limited sense. For example, two-letter top-level Internet domain names indicate the country involved, but this information is not specific and does not always accurately represent the physical location of the participating communication device. For many web sites, the only notion—based on information present in the protocol data—of where a user is located is generally limited to the center of a metropolitan city. While web site scenarios operate in an environment where users generally do not want their location known to the web site, consider that a user might volunteer their location information in the protocol in the right situation. The lack of consistent and accurate geospatial information for electronic communication data prevents several useful functions, such as, for example: looking up devices by a spatial area of interest (AOI); broadcasting information to all or a filtered set of devices in an AOI; collecting information for an AOI and archiving, querying, reporting, or aggregating the information; and triggering actions based on the physical location of a device.

### SUMMARY OF THE PRESENT INVENTION

The present invention addresses the aforementioned issues and others with current electronic communication protocols by attaching geospatial data to a protocol, routing data between electronic communication devices using this attached geospatial data, and providing algorithms that allow processing and filtering of information based on the attached geospatial data. This system improves performance and response time for spatial data processing by performing processing at the lowest level possible, and provides a solution that can be easily scaled by adding additional routing at intermediate spatial hierarchy levels.

### BRIEF DESCRIPTION OF THE DRAWINGS

FIG. 1 is a schematic representation of the OSI reference model.

FIG. 2 is a schematic representation of the TCP/IP protocol stack.

FIG. 3 is a schematic representation of a protocol stack for use in connection with one embodiment of the present invention.

FIG. 4 is one implementation of a spatially hierarchical network routing structure in accordance with one aspect of the present invention.

FIG. 5 is a sample layout of an RTP packet structure.

FIG. 6 is a sample layout of geospatial-related information for use in connection with the present invention.

FIG. 7 is a sample layout depicting two hosts exchanging geospatial information in accordance with one embodiment of the present invention.

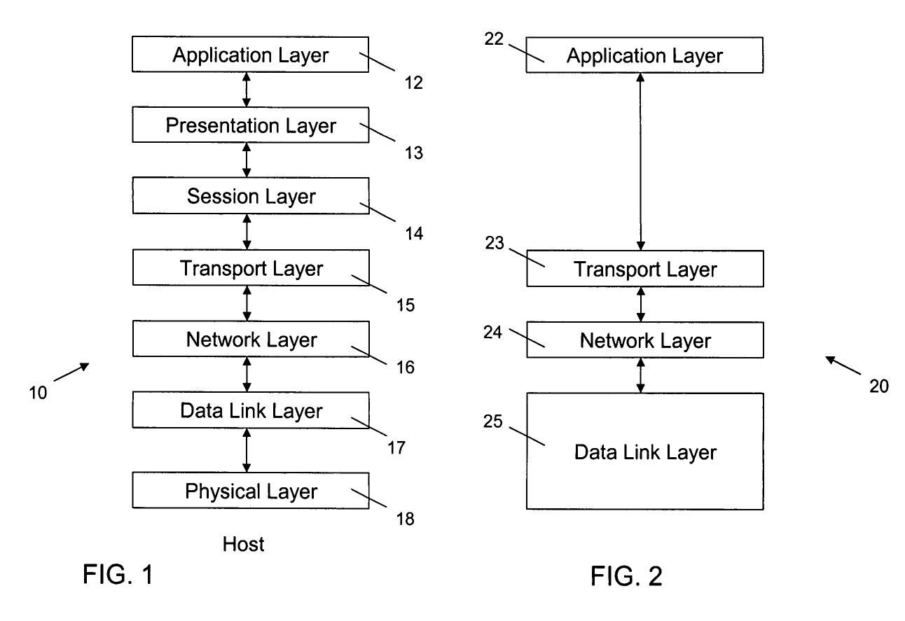

### DETAILED DESCRIPTION OF THE PREFERRED EMBODIMENTS

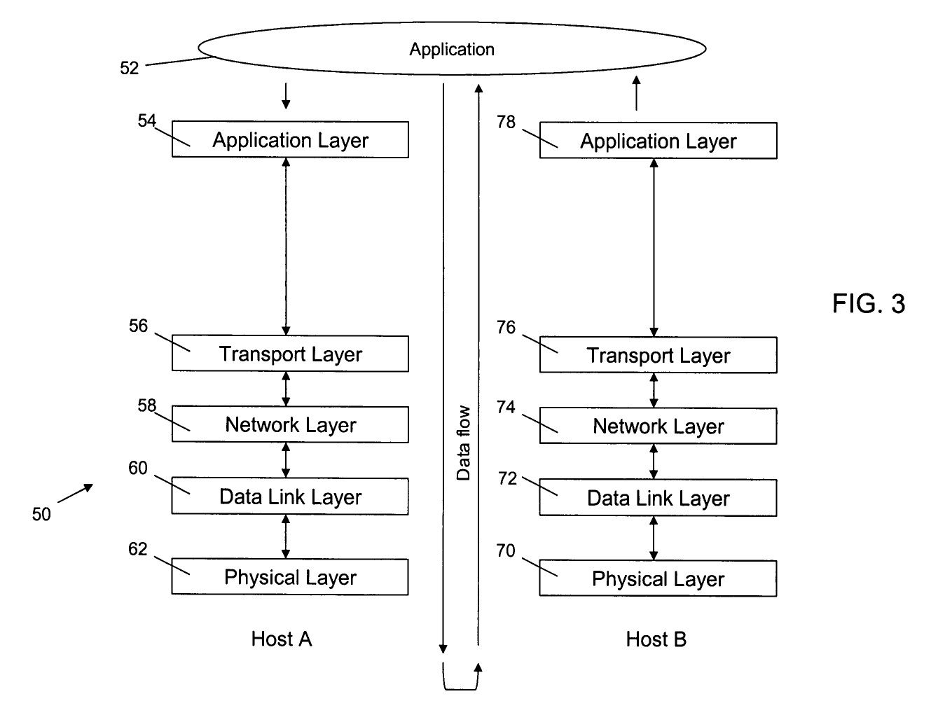

FIG. 3 shows a protocol stack 50 which can be used in one implementation of the present invention. While five layers are shown therein, it will be appreciated that the present invention can be adapted to implement the seven layer OSI Reference Model addressed above or other models suitably conforming to the requirements of the present invention. As shown in FIG. 3, an application 52 can communicate with stack 50 at the application layer 54 on host A network. The application layer 54 passes the data being communicated to each succeeding lower layer (56, 58, 60) and finally to the physical layer 62. In return on the host B network, data from the remote application is received by the physical layer 70 which in turn passes the data to each succeeding higher layer (72, 74, 76) and finally to the application layer 78 and on to the Application 52.

When data is received at the application layer 54 from application 52, it is encapsulated between a header and a trailer added by the layer, and the resulting data structure can be called the Packet Data Unit (PDU). The header of the PDU generally contains data to identify the contents, destination and length of the encapsulated data, as well as the data's source. The trailer generally contains error detection/correction data. Upon receiving a PDU from a higher layer, each successive lower layer adds its own appropriate header and trailer information to the PDU, which thus grows in size.

When a PDU is received by a higher layer from a lower layer, the process is reversed, with the header and trailer for the lower layer being removed as the destination is extracted from the header and error correction is performed. The now-smaller PDU can then be transferred to the next higher layer.

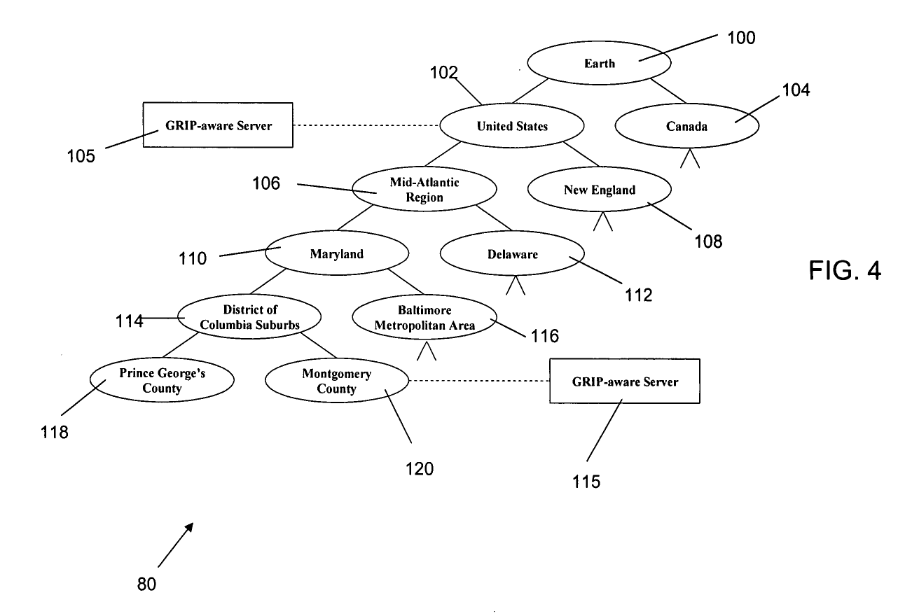

In one embodiment of the present invention, the invention geospatially enables electronic communication protocols by providing a hierarchical routing network such as shown in FIG. 4. As shown in FIG. 4, a spatially hierarchical network routing structure 80 is provided wherein each oval (e.g., 100, 102) represents one or more spatially aware electronic communication protocol routers. Although the drawn structure is a binary tree, this is not a requirement or even a fully representative single implication of the present invention. In this example, however, there can be physical or virtual routers for the Earth 100, the United States 102 and Canada 104, with appropriate sub-categories of regions and even further sub-sub categories down to a highly granular level (e.g., counties or buildings). As shown in FIG. 4, the United States physical or virtual router connects to the Mid-Atlantic router 106 and the New England router 108. The Mid-Atlantic router connects to the Maryland 110 and Delaware 112 routers. The Maryland router connects to the Washington, D.C. suburbs 114 and Baltimore metropolitan area 116 routers. The DC suburbs router communicates with the Prince George's County 118 and Montgomery County 120 routers, and the hierarchy can be extended as far as necessary to implement the specific function required. While the hierarchical structure in FIG. 4 is divided along administrative and jurisdictional boundaries, other embodiments of the present invention can divide geospatial areas in other ways, such as, for example, into rectangular areas of the Earth's surface. FIG. 4 also depicts examples of GRIP-aware servers 105, 115 that can consolidate, filter, aggregate, query, and broadcast data at different levels without requiring filtering of data outside the AOI. GRIP-aware servers can filter information with speed and precision by inspection of the GRIP packet header for each PDU. This alleviates the need to process the entire packet for information deemed irrelevant to the GRIP-aware server, for example, which may be information from a source located outside of the area of concern.

The basic routing network (such as shown in FIG. 4) is spatially hierarchical, with lower-level routers responsible for communications between devices in a smaller spatial area of responsibility (AOR) than higher-level routers. Lower-level routers are also responsible for interacting with higher-level routers when communications are required between devices in different lower-level AORs. In one embodiment of the invention, the spatial AOR of a lower-level router is not restricted to be a subset of the AOR of a single higher-level router. For example, one hypothetical scenario might have the AOR of the New York metropolitan area router covering subsets of the New York, New Jersey, and Connecticut state-level router AORs.

The basic routing network can be a combination of one or more physical and/or virtual routers. Although physical routers have been described, in one embodiment a single physical router device can be configured to route information geospatially according to a hierarchical memory map.

The hierarchical structure of the routing network according to the present invention allows efficient broadcast of data to all communication devices in a given area, as well as efficient filtering of data coming from an area. Data can also be spatially indexed at the lowest router level, reducing the size of the spatial database as well as the time required to query it. Hardware-based geospatial calculations can be used to improve the performance and scalability of the system, and geospatial metadata to attach to the communication protocol can also be generated in hardware. When network devices fail or are secured for maintenance, the system can be set up to automatically reconfigure so as to maintain full network connectivity.

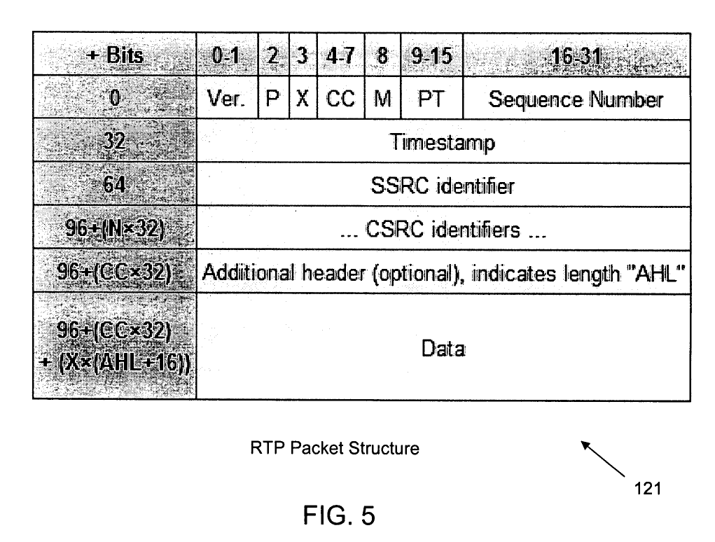

To enable and facilitate communication within the network 80, the present invention works with and provides at least one electronic communication protocol as described above and attaches geospatial data to the communication protocol. The geospatial data can be attached in several ways. In one embodiment of the present invention, geospatial data is attached to an electronic communication protocol by developing a geospatially referenced internet protocol (GRIP) that would operate above a standard current protocol. For example, in the same manner that the Transmission Control Protocol (TCP) operates over the Internet Protocol (IP) as TCP/IP, communication devices can be programmed to operate using GRIP. This method requires programming communication devices below the application level (e.g., at the presentation or session layer), but has the advantages that it can operate on the current widespread IP infrastructure and allows full control of the content and format of the GRIP. This approach is analogous to the Voice over IP (VoIP) protocol, which uses RTP (real time protocol) to help ensure that packets are delivered timely. FIG. 5 shows a sample layout 121 of a packet structure for RTP.

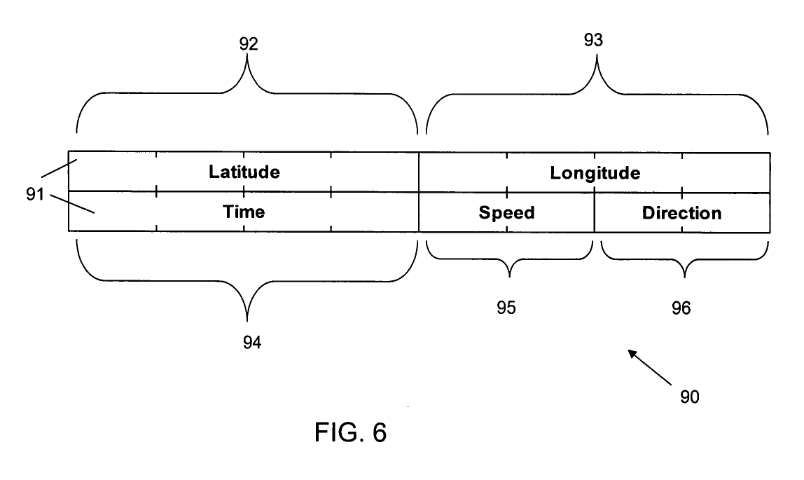

The data to be attached can vary. In one embodiment of the present invention, the geospatial data includes latitude, longitude, time, speed and direction. FIG. 6 shows a sample layout 90 of a geospatial data protocol that can be used in accordance with one embodiment of the present invention. Each segment 91 can represent one byte of data, for example. The length and order of data fields and the list of fields present is not fixed; however, in the example shown, latitude 92 and longitude 93 are represented as four bytes each, time 94 is represented as four bytes, and speed 95 and direction of travel 96 are represented as two bytes each. While the length, order and list of data fields need not necessarily be fixed, the present invention can require at least the ability to georeference the data source location to a desired tolerance given solely the information specified by the protocol.

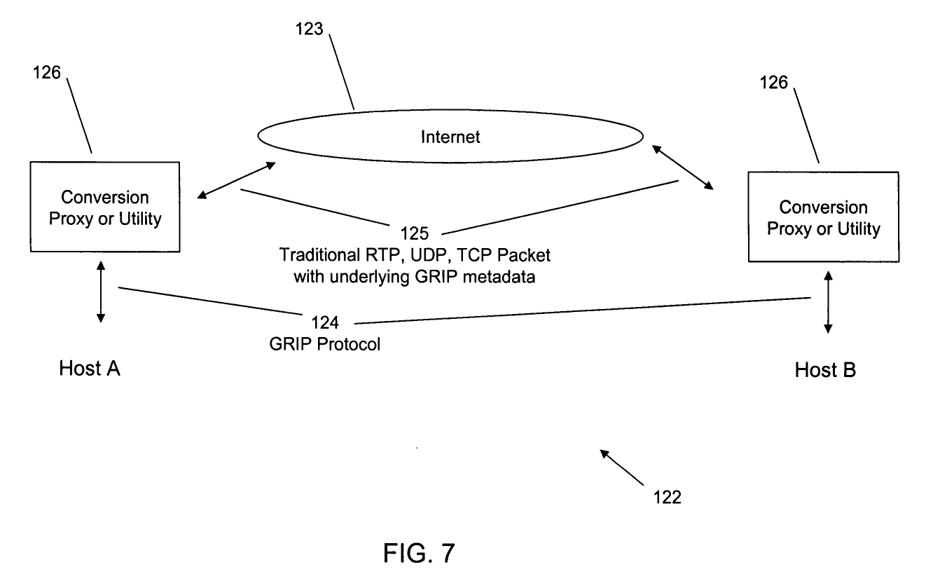

The second method in accordance with the present invention for adding geospatial data to a protocol is by expanding the metadata structure for a current protocol or reusing existing space in the current metadata structure. This method allows data to travel over current networks and protocols without change, only requiring the source and destination applications at the application level to understand the additional geospatial information. Computer programs executed at the application level can be used to process and interpret the additional geospatial information. For example, a computer program running on a laptop device equipped with a GPS can create a traditional TCP or UDP (User Datagram Protocol) packet that encapsulates the metadata information typically present in a GRIP header packet, and transmit this information to another host or server such that the information is routed traditionally. However, this method also allows redesign of network routing algorithms to take advantage of the geospatial information encoded in the protocol header. This method can be employed in situations where tunneling through traditional communication protocols is required or desired. FIG. 7 shows layout 122 that depicts two hosts that exchange geospatial information by using traditional packets 125 over the Internet 123. This exchange is facilitated by conversion proxies (or utilities) 126 such that each host receives the information as intended in the GRIP protocol, where the proxy servers or utility software applications can form and transmit the appropriate protocols. In one embodiment of the present invention, a single proxy server can serve as a gateway to a cluster of GRIP aware devices, hosts, and GRIP-aware servers.

A third method in accordance with the present invention for adding geospatial data to communication protocols is to either replace or re-purpose the underlying transport protocol (e.g., IP). The address space for the latest version of IP (e.g., IPv6) is large enough to allow detailed representation of any location on the Earth's surface by using an appropriate computation to convert between geographic locations and IPv6 addresses. Re-purposing IPv6 in this manner allows direct use of current communication hardware, although requiring a dedicated network to prevent conflicts in the IPv6 address space. Replacing IP with a new protocol in this way can also require a dedicated network as well as new communications hardware. In one embodiment of the present invention, one more IPv6 routers is not aware that every instance of a MAC (Media Access Control) address or IPv6 address is actually a virtual representation of a small geographic unit on the earth's surface. This convenient workaround can allow a single router to direct flows of location-based information from one location on the earth's surface to another. This workaround might support the processing of information at the software application level which can reside and be listening to a particular range of IPv6 addresses or at a specific MAC address.

With the geospatial data attached as described above, the routing of the data can occur to/from electronic communication devices based on the attached geospatial data. In one embodiment of the present invention, the electronic communication devices can be portable or mobile devices such as cellular telephones, personal digital assistants (PDAs), laptops or the like.

In addition to attaching the geospatial data and routing the data appropriately, the present invention provides utility algorithms that allow processing and filtering of information based on the attached geospatial data. The following non-exclusive list of utility algorithms can be employed for full utilization of the geospatial data. One possible embodiment of these algorithms is a programmable device inserted into the communication network.

Device Lookup by Spatial Location

The present invention creates the ability to query by an AOI and determine all devices in that area. This function is performed because one or more GRIP routers is aware of the devices that recently transmitted packets—for example, status update information—and their respective location. In one embodiment of the present invention, a GRIP-aware server, such as that which was described in FIG. 4, can maintain a registry of the most recent location information for each specific device, and can relay this information to an application that might query for it. This query is useful, by way of example, for military forces with a need for a lightweight solution for generating a view of the battlespace, as well as for natural disaster and terrorist attack situations in which the locations of both victims and first responders are critical. This capability is further useful for a commercial business that has to track the locations of a fleet of vehicles or inventory, for example.

Geospatial Consolidation and Aggregation

The present invention allows data to be consolidated at any level in the routing hierarchy for caching, archiving, querying, or reporting. Because the GRIP protocol identifies the origination location of the source information, streams of data can be routed due to their proximity no different than a firewall can divert traffic coming from a particular subnet address, for example. The invention also provides automatic aggregation of lower-level data into summary information for consumption in other geospatial areas. In one embodiment of the present invention, this aggregation is accomplished by programming a GRIP-aware server to ingest multiple streams of data, perhaps from a number of single points in an area, and transmitting an ellipse or polygon representative of all the points to the intended recipients. For example, a military fire team in Baghdad may need to know the exact location of all other fire teams in Baghdad, but a fire team in Kabul may only be interested in an approximate location for the aggregated higher-level Baghdad unit that contains all the fire teams in that area.

Spatial Data Queries

The present invention further provides the ability to query for data by geospatial area as well as by other factors. The query can be executed, for example, at the lowest level possible, which is the geospatial router or GRIP-aware server with the smallest AOR that completely covers the area queried. Spatial data queries can be cached for faster response times, and machine learning algorithms can be applied to predict the best queries to cache or pre-cache (i.e., some likely queries may be executed before they are actually presented to the system). For example, a GRIP-aware server in one embodiment can serve as a cache for the most recent location for all devices reporting in the last 24 hours, and a message can be sent to such a server to determine which devices are within a certain distance of a specific road provided the location characteristics of the road is provided.

Geospatial Triggers and Notifications

The present invention allows actions to be triggered and notifications to be sent based on the physical location of a communication device. The rule set applied to a particular device can be spatially hierarchical. For example, rules can be created to operate at the country, state, and county level, with local rules taking precedence. The present invention can determine the exact location of a device to be reported when a rule is triggered. A GRIP-aware server can perform these triggers because they can be in position to monitor GRIP message traffic for an AOI. If, for example, a device moves within some proximity threshold of some location, then the GRIP-aware server can send a message to the appropriate agent. It will be appreciated that all triggers and notifications can be based on aggregated data and may occur through the intervention of intermediary devices placed within the network.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A method for geospatially enabling electronic communication protocols, comprising the steps of:
providing a hierarchical routing network;
providing at least one electronic communication protocol;
attaching geospatial data to the communication protocol;4
routing data between at least two electronic communication devices based on the attached geospatial data; and
applying at least one utility algorithm to allow processing or filtering of information based on the attached geospatial data.

2. The method of claim 1 wherein the step of attaching geospatial data includes the step of providing a geospatially referenced internet protocol (GRIP) operating above the at least one protocol.

3. The method of claim 1 wherein the step of attaching geospatial data includes the step of expanding the metadata structure for the at least one protocol.

4. The method of claim 1 wherein the step of attaching geospatial data includes the step of reusing existing space in the current metadata structure for the at least one protocol.

5. The method of claim 1 wherein the step of attaching geospatial data includes the step of replacing or re-purposing the underlying transport protocol.

6. The method of claim 1 wherein the step of routing data between at least two electronic communication devices includes the step of providing at least one lower level router and at least one higher level router.

7. The method of claim 6 including the step of spatially indexing the data at the lower router level.

8. The method of claim 1 wherein the step of applying at least one utility algorithm includes the step of applying an algorithm for device lookup by spatial location.

9. The method of claim 1 wherein the step of applying at least one utility algorithm includes the step of applying an algorithm for geospatial data consolidation and aggregation.

10. The method of claim 9 wherein the geospatial data consolidation and aggregation is for at least one of: caching, archiving, querying, or reporting.

11. The method of claim 1 wherein the step of applying at least one utility algorithm includes the step of applying an algorithm for spatial data queries [at the lowest level possible].

12. A system for geospatially enabling electronic communication protocols, comprising:
a hierarchical communications network having at least one electronic communication protocol;
a processor for executing a first computer program for attaching geospatial data to the at least one communication protocol;
a router for routing data between at least two electronic communication devices based on the attached geospatial data; and
a processor for executing a second computer program for applying at least one utility algorithm to allow processing or filtering of information based on the attached geospatial data.

13. The system of claim 12 wherein the executed first computer program provides a geospatially referenced internet protocol (GRIP) operating above the at least one protocol.

14. The system of claim 12 wherein the executed first computer program expands the metadata structure for the at least one protocol.

15. The system of claim 12 wherein the executed first computer program reuses existing space in the current metadata structure for the at least one communication protocol.

16. The system of claim 12 wherein the first computer program replaces or re-purposes the underlying transport protocol.

17. The system of claim 12 wherein the router comprises at least one lower level router and at least one higher level router.

18. The system of claim 17 wherein the router spatially indexes the data at the lower router level.

19. The system of claim 12 wherein the second computer program applies an algorithm for device lookup by spatial location.

20. The system of claim 12 wherein the second computer program applies an algorithm for geospatial data consolidation and aggregation.

21. The system of claim 20 wherein the geospatial data consolidation and aggregation is for at least one of: caching, archiving, querying, or reporting.

22. The system of claim 12 wherein the second computer program applies an algorithm for spatial data queries [at the lowest level possible].

23. A method of querying communication devices within a communications network by a spatial area of interest (AOI), comprising the steps of:
attaching geospatial data to at least one communication protocol associated with the network;
identifying one or more communication devices within the AOI based on the geospatial data; and
receiving at least one communication from one of said identified devices indicating its presence within the AOI.

24. The method of claim 23 including the step of broadcasting information to all or a filtered set of devices identified in the AOI.

25. The method of claim 23 including the step of archiving, querying, reporting, or aggregating information obtained in the communication from the identified device.

26. The method of claim 23 including the further step of executing a computer application for triggering actions based on the physical location of a device.
